(19) United States
(12) Patent Application Publication
(10) Pub. No.: US 2023/0131273 A1
(43) Pub. Date: Apr. 27, 2023

(54) POLYMER COMPOSITIONS WITH ANTIMICROBIAL AND WAVELENGTH-SHIFTING NANOPARTICLES

(71) Applicant: EVOQ NANO, INC., Salt Lake City, UT (US)

(72) Inventor: William H. Niedermeyer, West Jordan, UT (US)

(21) Appl. No.: 17/970,172

(22) Filed: Oct. 20, 2022

Related U.S. Application Data
(60) Provisional application No. 63/270,272, filed on Oct. 21, 2021.

(51) Int. Cl. C08J 3/20; C08K 3/08; C08K 7/18

(52) U.S. Cl. CPC C08J 3/203; C08K 3/08; C08K 7/18; C08K 2003/0806; C08K 2003/0831; C08K 2201/011; C08K 2201/005; C08K 2201/016; C08K 2201/014; B82Y 30/00

(57) ABSTRACT

Disclosed are embodiments of polymer compositions and systems that contain antimicrobial and wavelength-shifting metal nanoparticles. The polymer compositions containing metal nanoparticles protect exposed materials from UV radiation. The polymer compositions containing metal nanoparticles down convert incoming UV light to light that may have a longer wavelength. Unexpectedly, by selecting at least two differently configured nanoparticle components (e.g., different in size, shape, or both), each with specific particle size distribution, it is possible to effectively protect an area from damage resulting from exposure to UV radiation. In addition, spherical silver nanoparticles do not cause bacteria to become resistant as do convention silver nanoparticles made by chemical synthesis.

### CROSS-REFERENCE TO RELATED APPLICATION

This application claims the benefit of U.S. Provisional Application No. 63/270,272, filed Oct. 21, 2021, which is incorporated by reference in its entirety 0.1609

### BACKGROUND

### Technical Field

This disclosure relates to polymer compositions and systems that contain antimicrobial and wavelength-shifting nanoparticles and uses thereof in polymer manufacturing processes.

### Related Technology

Polymers used in medical and other applications are typically inexpensive and can be used across many different medical functions. Polymeric articles of manufacture may be manufactured using injection molding processes. One of the issues with mold injected polymers is the surface finish of the end product can be sponge-like, with pores that can extend several microns deep into the product. FIG. 1 is a scanning transmission electron microscope (STEM) image of a surface of polystyrene from thermal extruded pellet, which has a high degree of porosity. This can be a perfect protective breeding ground for bacteria and microbes to grow and is a big concern for hospitals and insurance policy holders. For this reason, the management of polymers used in areas of high sensitivity requires expensive and rigorous sterilization and storage procedures, which may still result in aggravated tissues when the infected polymers are used in delivering substances to patients. Worse, drug resistant bacterial and/or fungal infections may cause expensive healthcare maintenance and even death, if passed to patients from infected polymer products.

The overuse of antibiotics has contributed to an overall antibiotic resistance seen in newly discovered strains of microbes. There is concern that an increase in antibiotic resistance of microbes may lead to “superbugs” that may be unable to be controlled with modern, conventional technologies. Currently, there are few conventional methods of disinfecting and microbial control without the use of antibiotics. Medical devices that incorporate antibiotics cannot stop infection and formation of biofilms when a patient has microbes with antibiotic resistance. In such cases, the use of antibiotics in polymeric materials does not protect the patient from infection and may give a false sense of security.

There are attempts to incorporate ionic colloidal silver and silver nanoparticles into polymeric materials to import antimicrobial activity to polymers. However, antimicrobial resistance has now been discovered for colloidal silver (traditional silver nanoparticles made by chemical processes) and ionic silver. McNeilly et al., “Emerging Concern for Silver Nanoparticle Resistance in Acinetobacter baumannii and Other Bacteria,” Front. Microbiol., 16 Apr. 2021, discuss the emergence of several antibiotic-resistant bacteria, including Acinetobacter baumannii, Enterococcus faecium, Staphylococcus aureus, Klebsiella pneumoniae, Acinetobacter baumannii, Pseudomonas aeruginosa, and Enterobacter spp. Of these, A. baumannii was of particular concern and was found to also have developed resistance to silver nanoparticles, as was E. Coli, Enterobacter cloacae, S. typhimurium, B. subtilis, S. aureus. P. aeruginosa, K. pneumoniae, Serratia marcescens, Acinetobacter spp.

Silver, “Bacterial silver resistance: molecular biology and uses and misuses of silver compounds,” FEMS Microbiology Reviews, Volume 27, Issue 2-3, June 2003, Pages 341-35, discusses silver-resistant Salmonella, and Escherichia coli. Elkrewi, et al., “Cryptic silver resistance is prevalent and readily activated in certain Gram-negative pathogens,” J. Antimicrob. Chemother., 2017 Nov. 1; 72(11):3043-3046 discloses silver nanoparticle resistance by gram negative pathogens, such as Enterobacter spp., Klebsiella spp. Escherichia coli, Pseudomonas aeruginosa, Acinetobacter spp., Citrobacter spp., and Proteus spp. Hosney, “The increasing threat of silver-resistance in clinical isolates from wounds and burns,” Infect Drug Resist. 2019; 12: 1985-2001 discusses silver-resistant Klebsiella pneumoniae, Staphylococcus aureus, Escherichia coli, Enterobacter cloacae, Pseudomonas aeruginosa, and Acinetobacter baumannii. Percival, et al., “Bacterial resistance to silver in wound care, J. Hospital Infection, Vol. 60, Issue 1, May 2005, pp. 1-7, discusses the fear and possibility of silver-resistant microbes in wounds. K [symbol] dziora, et al., “Consequences Of Long-Term Bacteria's Exposure To Silver Nanoformulations With Different PhysicoChemical Properties,” Intl. J. of Nanomedicine, 2020:15 199-213, discusses silver-resistant gram positive and gram negative bacteria.

An article entitled “Are Silver Nanoparticles a Silver Bullet Against Microbes?” Jul. 13, 2021, https://news.engineering.pitt.edu/are-silver-nanoparticles-a-silver-bullet-against-microbes/ (accessed Oct. 12, 2022), discusses silver nanoparticle resistant E. coli., stating: “‘In the beginning, bacteria could only survive at low concentrations of silver nanoparticles, but as the experiment continued, we found that they could survive at higher doses . . . . Interestingly, we found that bacteria developed resistance to the silver nanoparticles but not their released silver ions alone.’ The group sequenced the genome of the E. coli that had been exposed to silver nanoparticles and found a mutation in a gene that corresponds to an efflux pump that pushes heavy metal ions out of the cell. ‘It is possible that some form of silver is getting into the cell, and when it arrives, the cell mutates to quickly pump it out . . . . More work is needed to determine if researchers can perhaps overcome this mechanism of resistance through particle design.’”

Also, silver nanoparticles made by chemical synthesis have external bond angles and edges where silver ions can be released. Adding metal nanoparticles that release ions into polymers yields nanoparticle-impregnated polymers and plastics that are a source of unwanted metal ions, such as silver ions, which are generally toxic to human and animal tissues.

Additionally, exposure to solar radiation can cause weakening and other structural damage to polymers. When absorbed by polymers, UV energy may excite electrons, creating free radicals that can lead to degradation of the plastic. Polymers that have been affected by UV radiation may appear chalky, the surface of the polymer may become brittle, and there may be a noticeable color change on the surface of the polymer. UV-caused degradation may lead to cracks in the polymer product and may cause the product to fail altogether. For example, UV radiation hitting polypropylene and/or low-density polyethylene may interact with tertiary carbon bonds within their structures, which can then interact with atmospheric oxygen. This can produce carbonyl groups in the main chain of the structure, leaving the plastic product prone to cracking or discoloration.

Ultraviolet radiation B (“UVB radiation”) is generally considered to lie within the range of about 280 to about 315 nanometers in wavelength. Ultraviolet radiation A (“UVA radiation”) is generally considered to lie within the range of about 315 to about 400 nanometers in wavelength. Ultraviolet radiation C (UVC) is generally considered to lie within the range of about 100 to about 280 nanometers in wavelength.

In view of the foregoing, there remains a need to find improved polymer materials that have antimicrobial properties to prevent colonization of implanted medical devices and without using metal nanoparticles that release toxic metal (e.g., silver) ions. There also remains a need to find improved polymer materials that can resist UV damage when exposed to the sun.

### SUMMARY

Disclosed are embodiments of polymer compositions and systems that are modified by incorporating therein antimicrobial and wavelength-shifting metal nanoparticles. In some embodiments, the polymer compositions containing metal nanoparticles protect exposed materials from UV radiation. In some embodiments, the polymer compositions containing nanoparticles down-convert incoming UV light to light of longer wavelength that are less damaging, or non-damaging, to polymer linkages.

The disclosed polymer compositions modified by incorporating metal nanoparticles also have antimicrobial properties to prevent colonization of microbes within pores of the polymer materials and structures. Such nanoparticle-modified polymers do not develop silver nanoparticle antibiotic resistance, as occurs with conventional colloidal silver and silver nanoparticles made via chemical synthesis. Surprisingly and unexpectedly, it has been found that nonionic silver nanoparticles formed by laser ablation do not lead to silver nanoparticle resistance, as occurs when using traditional colloidal silver and silver nanoparticles made by chemical synthesis and which are known release silver ions as their main mode of antimicrobial activity.

It is proposed that the new unique metal (e.g., silver) nanoparticles produced by high energy methods possessing smooth spherical morphologies and in narrow size distributions can be integrated into moldable polymers to mitigate bacteria or microbes that may setup around the plastic or within the plastics themselves. A method for adding the metal nanoparticles to the polymers in a non-interruptive process before the parts are made is also disclosed. Unexpectedly, spherical-shaped silver nanoparticles made by laser ablation and having a narrow particle size distribution do not result in microbial resistance, thus solving a tremendous problem with traditional antibiotics, silver compounds, colloidal silver, and silver nanoparticles.

In some embodiments, a metal nanoparticle composition may comprise (1) a carrier and (2) a plurality of metal (e.g., silver and/or gold) nanoparticles having a particle size and a particle size distribution selected so as to selectively and preferentially kill a target microbe selected from bacteria, fungi, and viruses.

Where the targeted microbe is a bacterium, anti-bacterial polymer compositions can include spherical metal (e.g., silver) nanoparticles having a particle size in a range of about 3 nm to about 14 nm, or about 5 nm to about 13 nm, or about 7 nm to about 12 nm, or about 8 nm to about 10 nm. Within these size ranges it is possible to select “designer anti-bacterial particles” of specific size that are particularly effective in targeting a specific bacterium.

Where the targeted microbe is a fungus, anti-fungal polymer compositions can include spherical metal (e.g., silver) nanoparticles having a particle size in a range of about 9 nm to about 20 nm, or about 10 nm to about 18 nm, or about 11 nm to about 16 nm, or about 12 nm to about 15 nm. Within these size ranges it is possible to select “designer anti-fungal particles” of specific size that are particularly effective in targeting a specific fungus.

Where the targeted microbe is a virus, anti-viral polymer compositions can include metal (e.g., silver) nanoparticles having a particle size in a range of about 8 nm or less, or about 1 nm to about 7 nm, or about 2 nm to about 6.5 nm, or about 3 nm to about 6 nm. Within these size ranges it is possible to select “designer anti-viral particles” of specific size that are particularly effective in targeting a specific virus.

In some embodiments, spherical metal (e.g., silver) nanoparticles having a mean diameter (number average) and a particle size distribution in which at least 99% of the spherical metal nanoparticles have a particle size within 30% of the mean diameter, or within 20% of the mean diameter, or within 10% of the mean diameter and/or wherein at least 99% of the spherical metal nanoparticles have a diameter within ±3 nm of the mean diameter, or within ±2 nm of the mean diameter, or within ±1 nm of the mean diameter.

In some embodiments, the compositions may comprise coral-shaped metal nanoparticles in addition to the spherical metal nanoparticles. Coral-shaped metal (e.g., gold) nanoparticles have a non-uniform cross section and a globular structure formed by multiple, non-linear strands joined together without right angles. In some cases, the coral-shaped metal nanoparticles can be used to potentiate the effect of spherical metal (e.g., silver) nanoparticles.

In some embodiments, metal nanoparticles can comprise at least one metal selected from the group consisting of silver, gold, platinum, palladium, rhodium, osmium, ruthenium, rhodium, rhenium, molybdenum, copper, iron, nickel, tin, beryllium, cobalt, antimony, chromium, manganese, zirconium, tin, zinc, tungsten, titanium, vanadium, lanthanum, cerium, heterogeneous mixtures thereof, and alloys thereof. Nanoparticles comprised of silver, gold, and mixtures and alloys thereof can be particularly effective.

Examples of metal (e.g., silver and gold) nanoparticles and nanoparticle compositions that can be used herein are disclosed in U.S. Pat. Nos. 9,849,512, 9,434,006, 9,919,363, 10,137,503, and 10,610,934, which are incorporated herein by reference.

In some embodiments, polymer compositions can be made from thermoplastic materials in which metal nanoparticles are incorporated therein, such as by coating polymer beads or pellets that are later thermoplastically formed into a desired structure of article of manufacture. In other embodiments, polymer compositions can be made from two-part compositions, where metal nanoparticles are included in one or both parts of the composition. In both cases, the metal nanoparticles become mixed throughout the polymer composition, either when in a molten state prior to molding and cooling or in a liquid state prior to molding and thermosetting.

In some embodiments, a method of protecting exposed materials from UV radiation comprises: (1) applying a polymer composition comprising a carrier and metal nanoparticles onto a substrate, and (2) the polymer composition reflecting and/or down converting at least a portion of the UV light incident upon the area.

In some embodiments, metal nanoparticles can comprise spherical-shaped metal (e.g., silver) nanoparticles and/or coral-shaped metal (e.g., gold) nanoparticles. In some embodiments the coral-shaped metal nanoparticles can be used together with spherical-shaped metal nanoparticles (e.g., in order to potentiate the spherical-shaped metal nanoparticles).

In some embodiments, nanoparticle compositions, such as single- and multi-component nanoparticle compositions, include a stabilizing agent capable of holding the nanoparticles in solution while still maintaining the functionality of the nanoparticles. In some embodiments, the metal nanoparticles are sprayed or coated onto already made packaging materials. In some embodiments, the metal nanoparticles are embedded into the package materials, such as thermoplastic wraps, polystyrene trays, solid plastics, polyurethanes, etc.

To manufacture shaped products from thermoplastic polymers, polymer granules used to mold polymeric articles of manufacture can be coated with metal (e.g., silver and/or gold) nanoparticles, such as by dispersing the metal nanoparticles in a volatile solvent, applying the dispersion to the polymer granules, and allowing the solvent to evaporate. When the metal nanoparticle-coated polymer granules are heated into a molten state within forming equipment, such as an auger, extruder, or injection molding machine, the metal nanoparticles become distributed throughout the molten thermoplastic polymer and the plastic materials and articles made therefrom.

In the case of two-part curable resins used to make thermoset polymer products, metal nanoparticles can be included in one or both parts of the two-part system. When the two parts are mixed together, the metal nanoparticles are blended throughout the mixture and will solidify in place within whatever product or article the composition is shaped into.

The portion of metal nanoparticles on the surface of the polymer material and/or embedded within pores in communication with the polymer surface will provide antimicrobial activity to prevent microbial growth on the surface of the polymer material. The metal nanoparticles will also protect the polymers materials from damage by UV radiation by down-converting incoming UV energy to a lower energy wavelength(s) that is less damaging, or non-damaging, to the polymer material.

Nonionic silver nanoparticles made by laser ablation so as to have no external bond angles and edges, and which do not release detectable quantities of silver ions when exposed to water, are already known to pass the EPA's sanitization surface tests using the nanoparticles in water as a spray on product. Polymer materials disclosed herein, with nanoparticles embedded inside, is a new approach allowing for surface wear to not deplete the nanoparticles available, even after abrasion or machining. Filaments were tested directly and test subjects similar to the peni-cylinders used in the surface sanitization programs were tested with accepted methods for measuring effective bacteria control.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIG. 1 is a scanning transmission electron microscope (STEM) image of a surface of polystyrene from thermal extruded pellets;

FIGS. 2A-2C are STEM images that illustrate thermoplastics containing silver (Ag) nanoparticles;

FIGS. 3A-B schematically illustrate a microbe after having absorbed spherical-shaped metal nanoparticle from a substrate and disulfide bonds being catalytically denatured by a spherical-shaped nanoparticle;

FIG. 4 illustrates a STEM image of silver (Ag) nanoparticles inside a MRSA SA62 drug resistant bacteria;

FIGS. 5A-5C illustrate STEM images of Tecoflex EG-93A-B20 thermoplastic polymer embedded with silver nanoparticles;

FIGS. 6A-6C illustrate STEM images of Isoplast 2510 thermoplastic polymer embedded with silver nanoparticles;

FIG. 7A illustrates industrial thermoplastic pellets that have been treated with silver (Ag) nanoparticles;

FIG. 7B illustrates an extruded filament from thermoplastic pellets such as those illustrated in FIG. 7A; and

FIGS. 8A-8B illustrate a close-up STEM image of an embedded spherical-shaped silver (Ag) nanoparticle in a thermoplastic material.

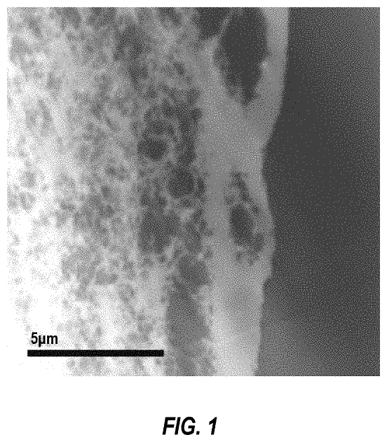

### DETAILED DESCRIPTION

Disclosed are embodiments of polymer compositions and systems that contain antimicrobial and wavelength-shifting metal nanoparticles. In some embodiments, the polymer compositions containing metal nanoparticles protect exposed materials from UV radiation. In some embodiments, the polymer compositions containing metal nanoparticles down-convert incoming UV light to light having a longer wavelength. In some embodiments, the polymer compositions containing metal nanoparticles have antimicrobial properties. Surprisingly and unexpectedly, nonionic silver nanoparticles formed by laser ablation do not lead to silver nanoparticle resistance, as occurs when using conventional colloidal silver and silver nanoparticles made by chemical synthesis and which are known to release silver ions as their main mode of antimicrobial activity.

In some embodiments, by selecting at least two differently configured nanoparticle components (e.g., different in size, shape, or both), each with specific particle size distribution, and stabilizing those at least two nanoparticle components with a stabilizing agent (such as natural-based polyphenol or other cream or gel or other surfactant), it is possible to effectively protect an area from damage resulting from exposure to UV radiation.

### I. INTRODUCTION

The term “nanoparticle” often refers to particles having a largest dimension of less than 100 nm. Bulk materials typically have constant physical properties regardless of size, but at the nanoscale, size dependent properties are often observed. Thus, properties of materials change as their size approaches the nanoscale and as the percentage of atoms at the surface of a material becomes significant. For bulk materials larger than one micrometer (or micron), the percentage of atoms at the surface is insignificant in relation to the number of atoms in the bulk of the material. The interesting and sometimes unexpected properties of nanoparticles are therefore largely due to the large surface area of the material, which dominates the contributions made by the relatively small bulk of the material.

The ability to select and use metal nanoparticles that can target specific types or classes of microbes provides a number of benefits. In the case where only certain nanoparticle sizes are effective in killing a particular microbe or class of microbes, providing metal nanoparticles within a narrow particle size distribution of the correct particle size maximizes the proportion of nanoparticles that are effective in killing the target microbe and minimizes the proportion of nanoparticles that are less effective, or ineffective, in killing the target microbe. This, in turn, greatly reduces the overall amount or concentration of nanoparticles required to provide a desired kill- or deactivation rate of a targeted microbe. Eliminating improperly sized nanoparticles also reduces the tendency of the composition to kill or harm non-targeted microbes or other cells, such as healthy mammalian or human cells. In this way, highly specific antimicrobial compositions can better target a harmful microbe while being less harmful or even non-toxic to humans, animals, and plants.

Moreover, because it has now been discovered that the nonionic metal nanoparticles formed by laser ablation do not result in antimicrobial resistance, which is unexpected given the extensive data for other silver nanoparticles, the concentration of silver nanoparticles required to effectively kill microbes remains essentially the same over time. This is in contrast to silver nanoparticles made by chemical processes, which have external bond angles and typically release silver ions as part of their antimicrobial activity. When antimicrobial resistance to conventional silver nanoparticles develops, increasing concentrations of such nanoparticles are necessary to maintain the ability to kill microbes.

In some embodiments, a metal nanoparticle composition may comprise (1) a polymer and/or polymeric structure or article of manufacture and (2) a plurality of metal nanoparticles having a particle size and a particle size distribution selected so as to selectively and preferentially kill a target microbe selected from bacteria, fungi, and viruses. The metal nanoparticles are advantageously nonionic, ground state, with no external edges or bond angles that can release metal ions. Spherical metal nanoparticles are typically used to kill microbes, although coral-shaped metal nanoparticles can provide anti-microbial activity, typically in combination with spherical metal nanoparticles.

In some embodiments, the metal nanoparticles may comprise or consist essentially of nonionic, ground state metal nanoparticles with no external edges or bond angles that can release metal ions. Examples include spherical metal nanoparticles, coral-shaped metal nanoparticles, and blends of spherical metal nanoparticles and coral-shaped metal nanoparticles.

The metal nanoparticles, including spherical and coral-shaped nanoparticles, may comprise any desired metal, mixture of metals, or metal alloy, including at least one of silver, gold, platinum, palladium, rhodium, osmium, ruthenium, rhodium, rhenium, molybdenum, copper, iron, nickel, tin, beryllium, cobalt, antimony, chromium, manganese, zirconium, tin, zinc, tungsten, titanium, vanadium, lanthanum, cerium, heterogeneous mixtures thereof, or alloys thereof. Nanoparticles comprised of silver, gold, and mixtures and alloys thereof can be particularly effective.

Absorption of solar radiation is much higher in materials composed of nanoparticles than it is in thin films of continuous sheets of material. In both solar PV and solar thermal applications, by controlling the size, shape, and material of the particles, it is possible to control solar absorption. The size-dependent property changes of nanoparticles include quantum confinement in semiconductor particles, surface plasmon resonance in some metal particles, and super-para-magnetism in magnetic materials.

In some embodiments, gold (Au) nanoparticles are included in the polymer compositions to down-shift incoming UV radiation. The gold nanoparticles may down-convert the light waves into less energetic and harmful light of longer wavelength(s). The gold nanoparticles may down-convert the light wavelengths towards the red zone of the light spectrum. In some embodiments, the gold nanoparticles are spherical. In some embodiments, the gold nanoparticles are approximately 1 to 40 nm in diameter.

In some embodiments, silver (Ag) nanoparticles are included in the polymer compositions to impart antimicrobial properties to the polymer compositions. The silver nanoparticles may be engulfed or ingested by microbes, and the silver nanoparticles may disrupt vital proteins of the microbe, effectively deactivating or killing the microbe. In some embodiments, the silver nanoparticles are spherical. In some embodiments, the silver nanoparticles are approximately 1 to 10 nm in diameter.

Examples of metal nanoparticles and nanoparticle compositions that can be used herein are disclosed in U.S. Pat. Nos. 9,849,512, 9,434,006, 9,919,363, 10,137,503, and 10,610,934, which are incorporated herein by reference.

### II. PLASTICS MANUFACTURING

Some common plastics manufacturing processes are extrusion and injection molding. Many medical thermoplastics are manufactured using one of the two processes. In the extrusion process, polymeric pellets or granules are fed into an extrusion machine by a hopper. The polymeric pellets or granules are heated and melted inside a barrel, sometimes with the aid of an auger. The melted polymer is then pushed through a metal die by a screw auger, creating a fixed, continuous shape. The resulting polymer object can be cut or trimmed as desired. The extrusion process is commonly used for manufacturing pipes, tubes, frames, symmetrical devices, etc.

Injection molding involves injecting a molten thermoplastic polymer into a pre-existing mold. The molten thermoplastic polymer can be formed by heating polymeric pellets or granules. Once injected into the mold, the polymer will cool and harden into its final shape. The molten polymer is generated similarly to the extrusion process—polymer pellets or granules are fed into a barrel or other chamber by a hopper where they are then heated (and melted). A combination extrusion-injection molding process may be used when a hollow product is desired.

Additives may be included in the plastic pellets or granules, which are melted down to create the final products. Colorants, stiffeners, and other enhancers may be sprayed or coated onto the pellets prior to heating. For example, colorants are often dissolved or dispersed in a volatile solvent and then sprayed onto the pellets. Upon heating, the volatile solvent will evaporate off, leaving the colorant evenly distributed among the pellets. The colorant will get evenly incorporated into the melted plastic and result in a uniformly colored product. Other additives may similarly be incorporated into the final plastic products.

Thermoset polymers are also useful materials that can be molded or shaped into a desired object. Rather than being heated to above the melting point, thermoset polymers are typically formed by mixing two or more initial separate components that are formulated to react together to form an initial mixture that is flowable. The flowable mixture can be molded into a desired shape in similar fashion as thermoplastic materials. The components in the thermoset composition react together to cause polymerization and/or cross-linking to form a solidified thermoset polymer.

Examples of common materials for manufacturing medical devices and other polymer objects or configurations include silicone, epoxies, polystyrene (PS), polyethylene (PE), ethylene-vinyl acetate copolymer (EVA), polycarbonate (PC), polyurethane (PU), polyether ether ketone (PEEK), polylactic acid (PLA), polyester (PES), polypropylene (PP), polyethylene terephthalate (PET), polybutylene terephthalate (PBT), phenol-formaldehyde (PF), nylon or polyimides (PA), melamine formaldehyde (MF), polytetrafluoroethylene (PTFE), polyvinyl chloride (PVC), acrylonitrile butadiene styrene terpolymers (ABS), Kevlar, and carbon fiber-reinforced polymers. Thermoplastics, such as PE and PVC, may be melted and heated multiple times during plastics manufacturing. Thermoset plastics, such as PU and silicone, remain solid after a curing process has set the plastic.

### III. NANOPARTICLE COMPOSITIONS

Metal nanoparticles and nanoparticle compositions typically include nonionic, ground state, metal nanoparticles with no external edges or bond angles that can otherwise release metal ions. Nanoparticle compositions may include spherical metal nanoparticles, coral-shaped metal nanoparticles or a combination of the two. Spherical metal nanoparticles are typically used to kill microbes, although coral-shaped metal nanoparticles can provide anti-microbial activity, typically in combination with spherical metal nanoparticles.

Nonionic, ground state, spherical metal nanoparticles with no external edges or bond angles that can otherwise release metal ions, and compositions containing such nanoparticles, can be made according to the disclosure of U.S. Pat. Nos. 9,849,512, 10,137,503, and 10,610,934. Nonionic, ground state, coral-shaped metal nanoparticles with no external edges or bond angles that can otherwise release metal ions, and compositions containing such nanoparticles, can be made according to the disclosure of U.S. Pat. No. 9,919,363. Compositions that contain a mixture of spherical metal nanoparticles and coral-shaped metal nanoparticles are disclosed in U.S. Pat. No. 9,434,006. The foregoing patents are incorporated herein by reference in their entirety

Where the targeted microbe is a bacterium, anti-bacterial polymer compositions can include spherical metal nanoparticles having a particle size in a range of about 3 nm to about 14 nm, or about 5 nm to about 13 nm, or about 7 nm to about 12 nm, or about 8 nm to about 10 nm. Within these size ranges it is possible to select “designer anti-bacterial particles” of specific size that are particularly effective in targeting a specific bacterium.

Where the targeted microbe is a fungus, anti-fungal polymer compositions can include spherical metal nanoparticles having a particle size in a range of about 9 nm to about 20 nm, or about 10 nm to about 18 nm, or about 11 nm to about 16 nm, or about 12 nm to about 15 nm. Within these size ranges it is possible to select “designer anti-fungal particles” of specific size that are particularly effective in targeting a specific fungus.

Where the targeted microbe is a virus, anti-viral polymer compositions can include metal nanoparticles having a particle size in a range of about 8 nm or less, or about 1 nm to about 7 nm, or about 2 nm to about 6.5 nm, or about 3 nm to about 6 nm. Within these size ranges it is possible to select “designer anti-viral particles” of specific size that are particularly effective in targeting a specific virus.

In some embodiments, nanoparticle polymer compositions may include nanoparticles in a concentration of about 50 ppb to about 100 ppm, or about 100 ppb to about 50 ppm, or about 200 ppb to about 20 ppm, or about 400 ppb to about 10 ppm, or about 600 ppb to about 6 ppm, or about 800 ppb to about 4 ppm, or about 1 ppm to 3 ppm, or about 2 ppm by weight of the polymer composition. The compositions may include nanoparticles in a concentration range with endpoints defined by any two of the foregoing values of this paragraph.

a. Multi-Component Nanoparticle Compositions

In some embodiments, coral-shaped metal nanoparticles can be used in conjunction with spherical metal nanoparticles. In general, spherical metal nanoparticles can be smaller than coral-shaped metal nanoparticles and in this way can provide very high surface area for catalyzing desired reactions or providing other desired benefits. On the other hand, the generally larger coral-shaped nanoparticles can exhibit higher surface area per unit mass compared to spherical nanoparticles because coral-shaped nanoparticles have internal spaces and surfaces rather than a solid core and only an external surface.

In some cases, providing nanoparticle compositions containing both spherical and coral-shaped nanoparticles can provide synergistic results. For example, coral-shaped nanoparticles can help carry and/or potentiate the activity of spherical nanoparticles in addition to providing their own unique benefits. For example, smaller particles may offer better relative protection against UVB radiation, while relatively larger particles may offer better protection against UVA radiation. In some embodiments, a combination of spherical and coral-shaped nanoparticles can lead to synergistic, broad-spectrum protection with a greater amount of protection (e.g., amount of UV radiation reflected) per amount of active ingredient relative to single sized and/or shaped compositions.

In some embodiments, the mass ratio of spherical nanoparticles to coral-shaped nanoparticles in the nanoparticle composition can be in a range of about 1:1 to about 50:1, or about 2.5:1 to about 25:1, or about 5:1 to about 20:1, or about 7.5:1 to about 15:1, or about 9:1 to about 11:1, or about 10:1. The particle number ratio of spherical nanoparticles to coral-shaped nanoparticles in the nanoparticle composition can be in a range of about 10:1 to about 500:1, or about 25:1 to about 250:1, or about 50:1 to about 200:1, or about 75:1 to about 150:1, or about 90:1 to about 110:1, or about 100:1.

In some embodiments, spherical metal nanoparticles can have a diameter of about 40 nm or less, about 35 nm or less, about 30 nm or less, about 25 nm or less, about 20 nm or less, about 15 nm or less, about 10 nm or less, about 7.5 nm or less, or about 5 nm or less. The spherical metal nanoparticles can have a particle size distribution wherein at least 99% of the metal nanoparticles have a particle size within 30% of the mean diameter, or within 20% of the mean diameter, or within 10% of the mean diameter and/or wherein at least 99% of the spherical-shaped nanoparticles have a diameter within ±3 nm of the mean diameter, or within ±2 nm of the mean diameter, or within ±1 nm of the mean diameter. The spherical nanoparticles can have a potential of at least about ±10 mV (absolute value), or at least about ±15 mV, or at least about ±20 mV, or at least about ±25 mV, or at least about ±30 mV.

In some embodiments, at least a portion of the spherical and/or coral-shaped nanoparticles can comprises at least one metal selected from the group consisting of gold, platinum, silver, palladium, rhodium, osmium, ruthenium, rhodium, rhenium, molybdenum, copper, iron, nickel, tin, beryllium, cobalt, antimony, chromium, manganese, zirconium, tin, zinc, tungsten, titanium, vanadium, lanthanum, cerium, heterogeneous mixtures thereof, and alloys thereof. Nanoparticles comprised of silver, gold, and mixtures and alloys thereof can be particularly effective.

In some embodiments, at least one of either the first or second set of metal nanoparticles is selected so as to selectively reflect, block, and/or scatter a particular range of solar radiation. For example, the first set of metal nanoparticles may be selected as spherical-shaped metal nanoparticles having a smaller relative size and which therefore selectively reflect, scatter, and/or block more particularly UVB radiation, and a second set of metal nanoparticles may be selected as coral-shaped metal nanoparticles having a larger relative size and which therefore selectively reflect, scatter, and/or block more particularly UVA radiation. In other embodiments, the first and second set of nanoparticles may be both spherical or may be both coral-shaped, but have different sizes and/or size distributions.

In some embodiments, the compositions will include at least one spherical anti-microbial nanoparticle component and larger coral-shaped nanoparticle component. In these embodiments, the at least one selected spherical nanoparticle component will be present in the composition in a range of between about 1 and about 15 ppm (e.g., at least 1 and at most 15 ppm) and more particularly in the range of between bout 1 and about 5 ppm (e.g., at least 1 and at most 5 ppm). Additionally, in some embodiments, the larger coral-shaped nanoparticles will be present in the solution in a range of between about 1 and about 5 ppm (e.g., at least 1 and at most 5 ppm) and more particularly between about 1 and about 3 ppm (e.g., at least 1 and at most 3 ppm). It should be understood that the upper concentration is not restricted as much by efficacy, but more by product formulation cost. Thus, in other embodiments, the spherical-shaped nanoparticle component may present at a concentration above 5 ppm and/or the coral-shaped nanoparticle component may be present at a concentration above 3 ppm.

In some embodiments, compositions containing metal nanoparticles may be utilized in a plastics manufacturing process to produce plastic products with embedded nanoparticles. In some embodiments, compositions containing the metal nanoparticles are applied retroactively to products. For example, the composition may be a coating to be applied on the inside of plastic tubing. The composition may be coated onto the plastic tubing and provide antimicrobial and UV protection benefits.

### IV. ANTIBACTERIAL ACTIVITY OF NANOPARTICLES

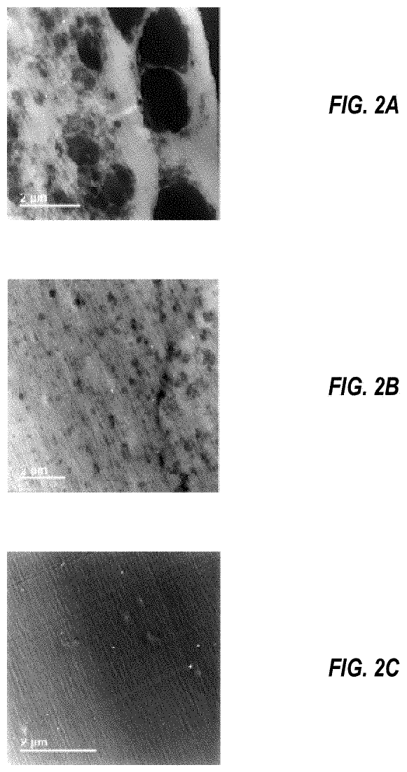

FIGS. 2A-2C are STEM images that illustrate thermoplastics containing silver (Ag) nanoparticles, which provides the polymer composition with antimicrobial and/or wavelength shifting properties.

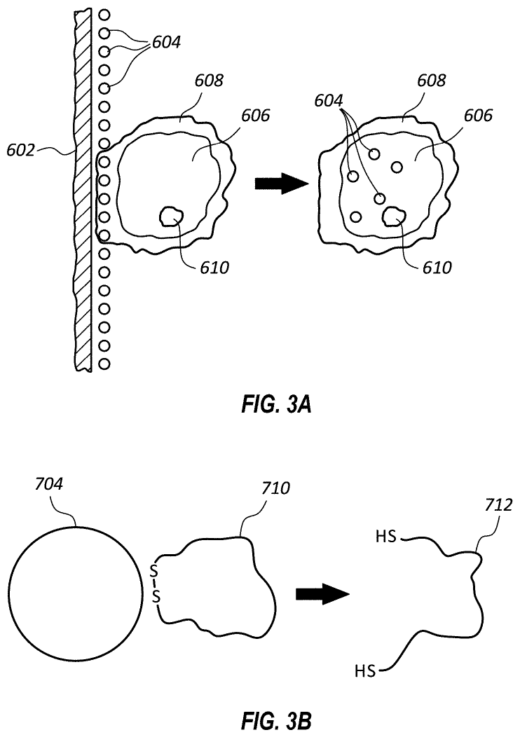

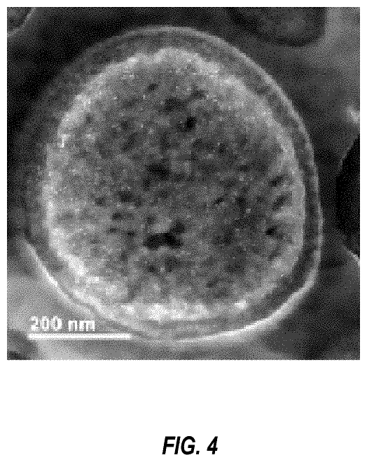

FIGS. 3A-3B and 4 schematically illustrate a microbe after having absorbed spherical-shaped metal nanoparticles from a substrate and the subsequent denaturation of microbial proteins. FIGS. 3A-3B schematically illustrate a microbe after having absorbed spherical-shaped metal nanoparticle from a substrate and disulfide bonds being catalytically denatured by a spherical-shaped nanoparticle.

FIG. 4 illustrates a STEM image of silver (Ag) nanoparticles inside a MRSA SA62 drug resistant bacterium. The STEM image in coordination with Electron Diffraction Spectroscopy provided confirmation of the sulfur stripping from the exposed site of disulfide bonds and ferredoxins.

FIG. 3A schematically illustrates a microbe 608 having absorbed spherical-shaped nanoparticles 604 from a solid substrate 602, such as by active absorption or other transport mechanism. Alternatively, spherical-shaped nanoparticles 604 can be provided in a composition (not shown), such as in a liquid or gel carrier. The nanoparticles 604 can freely move throughout the interior 606 of microbe 608 and come into contact with one or more vital proteins or enzymes 610 that, if denatured, will kill or disable the microbe.

One way that nanoparticles may kill or denature a microbe is by catalyzing the cleavage of disulfide (S—S) bonds within a vital protein or enzyme. FIG. 3B schematically illustrates a microbe protein or enzyme 710 with disulfide bonds being catalytically denatured by an adjacent spherical-shaped nanoparticle 704 to yield denatured protein or enzyme 712. In the case of bacteria or fungi, the cleavage of disulfide bonds and/or cleavage of other chemical bonds of vital proteins or enzymes may occur within the cell interior and thereby killing the microbe in this manner. Such catalytic cleavage of disulfide (S—S) bonds is facilitated by the generally simple protein structures of microbes, in which many vital disulfide bonds are on exposed and readily cleaved by catalysis.

Another potential mechanism by which metal (e.g., silver) nanoparticles can kill microbes is through the production of active oxygen species, such as peroxides, which can oxidatively cleave protein bonds, including but not limited to amide bonds.

Notwithstanding the lethal nature of nonionic metal nanoparticles relative to microbes, they are essentially harmless and non-toxic to humans, mammals, and healthy mammalian cells, which contain much more complex protein structures compared to simple microbes in which most or all vital disulfide bonds are shielded by other, more stable regions of the protein. In many cases the nonionic nanoparticles do not interact with or attach to human or mammalian cells and can be quickly and safely expelled through the urine without damaging kidneys or other cells, tissues, or organs.

In the particular case of silver (Ag) nanoparticles, the interaction of the silver (Ag) nanoparticle(s) within a microbe has been demonstrated to be particularly lethal without the need to rely on the production of silver ions (Ag⁺) to provide the desired antimicrobial effects, as is typically the case with conventional colloidal silver compositions. The ability of silver (Ag) nanoparticles to provide effective microbial control without any significant or actual release of toxic silver ions (Ag⁺) into the patient or the surrounding environment is a substantial advancement in the art. Whatever amount or concentration of silver ions released by silver nanoparticles, if any, is well below known or inherent toxicity levels for animals, such as mammals, birds, reptiles, fish, and amphibians.

The nonionic silver nanoparticles made using laser ablation disclosed herein have advantages over convention silver nanoparticles, which are known to cause antimicrobial silver nanoparticle resistance. Conventional or traditional silver nanoparticles are made according to various chemical synthesis methods. The nanoparticles formed using these various chemical synthesis methods tend to exhibit a clustered, crystalline, faceted, or hedron-like shape rather than a true spherical shape with round and smooth surfaces. Clustered nanoparticles can have a relatively broad size distribution. Silver nanoparticles can have rough surface morphologies with many edges, such as being hedron shaped as opposed to a truly spherical shape. In some cases, silver nanoparticles are formed as shells of silver formed over a non-metallic seed material.

As discussed in the Background section, conventional silver nanoparticles made using chemical processes are known to cause antimicrobial resistance, meaning their effective in killing microbes diminishes over time. Some studies have shown microbial resistance to ionic silver in only 6 passages or generations.

In contrast to conventional nanoparticles such made using chemical synthesis, which lose their antimicrobial effectiveness over time to a variety of bacteria and other microbes, the spherical-shaped nanoparticles formed by laser ablation described herein are solid metal, substantially unclustered, optionally exposed/uncoated, and have a smooth and round surface morphology along with a narrow size distribution. They have been shown to have stable anti-microbial activity even after 28 passages, with no diminution of antimicrobial activity, such as no reduction in the MIC (minimum inhibitory concentration).

In some embodiments, the nanoparticle composition includes nanoparticles in a concentration of 1 to 2 mg/L (1 to 2 ppm). In some embodiments, the composition also includes sodium laurel sulfate (SLS) at levels that are not antimicrobial. When SLS is mixed with silver nanoparticles, the silver nanoparticles have significantly higher antimicrobial effect. This is because the SLS encourages the uptake of nanoparticles associated with SLS into bacteria or other microbes.

### V. NANOPARTICLES—UV PROTECTION

Metal nanomaterials of the type disclosed herein and having diameters or sizes in the range of 10 to 40 nm have loose dielectric fields. When a large quantity of particles are together, the dielectric effect on light waves passing through does not attenuate but can be frequency-shifted either to the red or to the blue end of the electromagnetic spectrum. Polymer compositions that have a sufficient quantity of nanoparticles can effect the UV rays and shift them to the red end of the spectrum to reduce entry of photonic energy at a level that reduces overall damage.

In some embodiments, the polymer compositions can include metal nanoparticles having a high refractive index in order to reflect and/or scatter incident UV radiation. For example, nanoparticles and/or multi-component nanoparticles used in polymer compositions of the present disclosure can have a refractive index for UVA and/or UVB radiation of about 1.5 to about 4.6, or from about 2.0 to about 4.0, or from about 2.5 to about 3.5. In some embodiments, the refractive index of the nanoparticles and/or multi-component nanoparticles will be higher with respect to UVB radiation relative to UVA radiation (e.g., the refractive index increases with decreasing wavelength). In other embodiments, however, the refractive index of the nanoparticles and/or multi-component nanoparticles will be lower with respect to UVB radiation relative to UVA radiation (e.g., the refractive index increases with increasing wavelength).

In some embodiments, the polymer compositions can include nanoparticles having a photostability such that upon exposure to solar radiation (e.g., in an environment with a relatively high UV index of about 15), the nanoparticles and/or multi-component nanoparticles do not degrade or lose effectiveness in protecting against UV radiation (e.g., remain about 100% as effective, or remain about 95-100% as effective, or about 90-100% as effective, or about 80-100% as effective) over at least a given time period (e.g., about 1 hour, or about 2-4 hours, or about 4-6 hours, about 6-12 hours or longer, or even indefinitely).

In some embodiments, a polymer composition exhibits radiation protection properties. For example, some embodiments include a plurality of nanoparticles (e.g., beryllium and/or gold) configured to absorb harmful radiation (e.g., alpha particles, beta particles, and/or gamma radiation), thereby reducing or eliminating an amount of radiation passing through the nanoparticle treated material.

In some embodiments, gold nanoparticles uniformly dispersed throughout a plastics material down-convert incoming UV radiation into less harmful UV radiation. In some embodiments, the gold nanoparticles may down-shift incoming UV radiation by at least about 50 nm, or at least about 100 nm, or at least about 150 nm, such as by approximately 200 nm. In some embodiments, the gold nanoparticles may down-shift incoming UV radiation from UV light to visible light. In some embodiments, the gold nanoparticles may down-shift incoming UV radiation from UV wavelengths toward red and/or green wavelengths.

In some embodiments, gold nanoparticles uniformly dispersed throughout a polymer composition may absorb incoming UV radiation at a high energy and emit a lower energy wavelength, thereby imparting UV protection to the polymer composition and products made therefrom. Unexpectedly, the ability of the gold nanoparticles produced by methods outlined in U.S. Pat. No. 9,434,006 B2, incorporated herein by reference, to perpetually perform this down-shift in wavelength/radiation energy does not deteriorate with use. That is, the gold nanoparticles retain their UV protection capabilities indefinitely and are not degraded by incoming UV radiation. This beneficially prolongs the effectiveness of the polymer composition and plastic products made therefrom. This also means that lower concentrations of gold nanoparticles, or other wavelength-shifting metal nanoparticles, may be used resulting in products that are cheaper to produce while maintaining their integrity.

### VI. METHOD OF MANUFACTURING NANOPARTICLE EMBEDDED POLYMERS

Methods of adding nanoparticles to polymers in a non-interruptive manner are disclosed. Due to the methods of making the metal nanoparticles (referenced above), they can be produced in liquids directly applicable to polymer pellets or granules. For example, nanoparticles formed by laser-ablation (such as those described in U.S. Pat. Nos. 9,849,512 B2, 9,434,006 B2 and/or 9,919,363 B2) may be dispersed in a solvent, such as ethanol, isopropyl alcohol, or acetone, and applied to polymer pellets or granules prior to an extrusion or injection molding process. When the polymer pellets or granules coated with the nanoparticles are heated, for example before or during extrusion or injection molding processes, the solvent will evaporate off and the nanoparticles will be uniformly incorporated into the resulting molten plastic. The solvent may be a volatile solvent, gaseous solvent, or other appropriately evaporative solvent.

The resulting molten polymer containing a uniform dispersion of nanoparticles may then be used in extrusion, injection molding or other plastics processes to manufacture polymer-based products. The end polymer-based product will contain a uniform dispersion of nanoparticles throughout the entirety of the product. For example, tubing made from the molten polymer would contain a uniform distribution of nanoparticles enabled to be antimicrobial and to protect the tubing from UV radiation.

The polymer-based medical device or other article of manufacture will be protected from UV radiation and microbial growth. The metal nanoparticles embedded into the polymer-based device or article are capable of down-converting incoming UV radiation to lower energy radiation. This beneficially prevents general degradation of the polymer-based device or article from UV radiation. The polymer-based devices or articles will be able to be used for longer periods of time without cracking, discoloration, fogging, leakage, and/or failing completely.

Metal nanoparticles are also capable of deactivating or killing microbes, preventing microbial build up inside the polymer-based products. This beneficially prolongs to use of polymer-based products, particularly in medical circumstances (such as in hospitals or clinics). This also prolongs the sterilization of the polymer-based products, leading to lower costs in storage and sterilization procedures.

### VII. Examples

### Example 1

Metal nanoparticles (silver and/or gold) were suspended in 99.9% isopropyl alcohol. Inductive Coupled Plasma Optical Emission Spectrophotometry (ICPOES) was used to verify nanoparticle concentration. Dynamic Light Scattering (DLS) was used to verify nanoparticle size, which was found to be approximately 6 to 10 nm. STEM imaging with Electron Loss Spectroscopy (ELS) verified surface composition and shorter bond lengths.

Drug resistant bacteria were found to be killed in concentration ranges of 0.5 mg/L (0.5 ppm) to 2 mg/L (2 ppm) of nanoparticles. The highest concentration found to kill drug resistant bacteria was 8 mg/L (8 ppm). STEM imaging using no stain and a dark field camera with 3 nm of carbon coating allowed for tracking of the nanoparticles within and around a bacterium (see FIG. 4). The STEM imaging in conjunction with Electron Diffraction Spectroscopy (EDS) provided confirmation of the sulfur stripping from the exposed site of disulfide bond and ferredoxins.

### Example 2

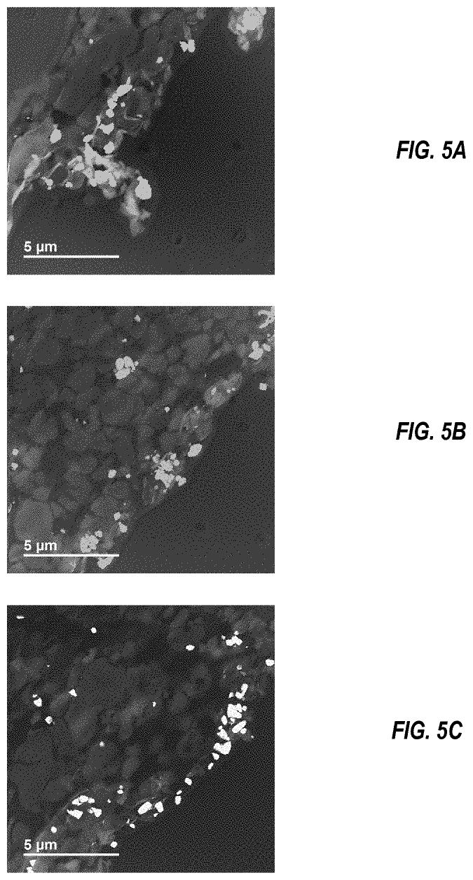

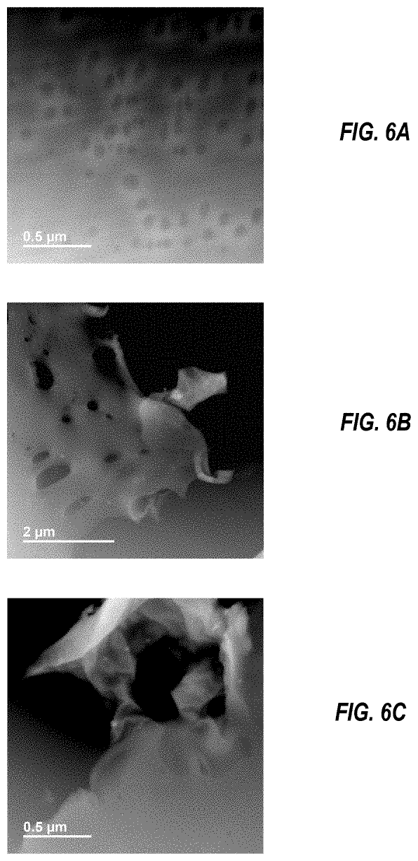

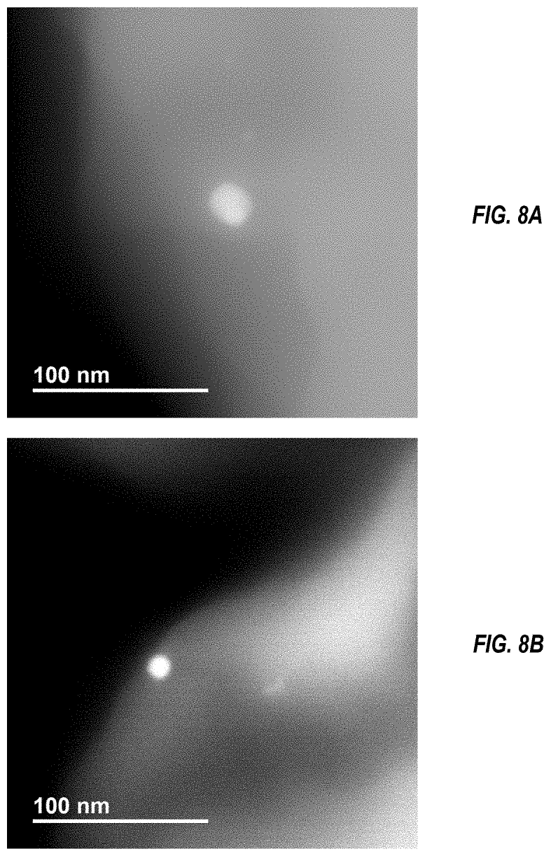

Polyethylene (PE) embedded with silver nanoparticles were tested for antibacterial properties. Two polymers, Tecoflex FG-93A-B20 (W filament) and Isoplast 2510 (D filament), were provided and each were treated with silver nanoparticles. FIGS. 5A-C illustrate STEM images of Tecoflex EG-93A-B20 thermoplastic embedded with nanoparticles. FIGS. 6A-6C illustrate STEM images of Isoplast 2510 thermoplastic embedded with nanoparticles. FIGS. 8A-B illustrate a silver nanoparticle embedded in a thermoplastic.

The silver nanoparticles were manufactured in isopropyl alcohol at a concentration of 38 mg/L (38 ppm). The alcohol mixture was applied to polymer beads or granules. The polymer beads or granules were melted for a final concentration of 6 mg/K (6 ppm) in the resulting PE polymer. This concentration of 6 mg/kg had previously been successful in surface antibacterial testing.

The alcohol was removed using a nitrogen blowdown system, leaving the nanoparticles distributed on the surface of the plastic beads. The polymer beads were then run through an extrusion melt system at 230° C. to form filaments. The nanoparticles on the surface of the polymer beads intermixed into the filaments produced. The filaments were then embedded in toming polymer and tomed to an 80-100 nm thickness and mounted on 200 mesh formvar Carbon B TEM grids for imaging.

Imaging was performed on a JEOL 2800 Scanning Transmission Electron Microscope (STEM) with a darkfield camera, brightfield camera and a secondary surface camera. Element mapping to 1 nm² resolution was performed to identify nanoparticles and particulates, using a dual EDS detector for triangulation and net count accuracy.

The Tecoflex FG-93A-B20 thermoplastic was light purple in color and required a clenching or cooling stage after melt extrusion at 230° C. As shown in FIGS. 5A-C, under STEM, large solid metal particles hundreds of nanometers in size were observed. EDS mapping revealed these to be barium sulfate.

Silver nanoparticles directly interact with sulfur chemistry and the overwhelming amount of barium sulfate (which is used as a filler and stiffener in Tecoflex FG-93A-B20) appears to have sequestered the silver nanoparticles. No direct nanoparticles were found on any grid from STEM imaging. Background silver was detected in the barium sulfate particles. Thermal disassociation was seen on the surface of the filaments, which was expected due to lack of thermal control in the final filament formation.

The Isoplast 2510 thermoplastic was darker purple in color and more glass like in surface finish. The Isoplast 2510 thermoplastic was melted at 230° C. and cooled at room temperature (22.5° C.). This thermoplastic used a phosphate as a filler and stiffener instead of barium sulfate. As shown in FIGS. 6A-C, the phosphates did not interact with the Ag nanoparticles, and it was easy to find and element map the silver nanoparticles present. Isoplast 2510 is a more suitable candidate to create an equal distribution of the silver nanoparticles within the plastic. The surface did not have the same type of thermal disassociation.

Concentrations of material to obtain the desired effect may be scaled appropriately. Further testing with several other plastics by similar analytical methods as described herein is a continuing process depending on the purpose and need of the material.

### Example 3

Typical surface antibacterial testing is conducted using an accepted standard known as a peni-cylinder. The conventional peni-cylinder has an outside diameter of 7.8 mm, an inside diameter of 5.8 mm and is 9.9 mm in length. The surface area can be calculated as:

Aₛ=(Outside surface area)+(inside surface area)+2(end surface area)

Aₛ=242.6 mm²+180.4 mm²+42 mm²

Aₛ=465 mm²

Because the ends of the peni-cylinder have a 45° taper, the overall surface area is a little less than calculated but the difference is inconsequential.

20 mm long filament analogs to the peni-cylinder were used for antibacterial testing. The filament diameter was 1.2 mm and for every 1 mm in length there is 7.5 mm² of outside surface area and an ends surface area of 2.3 mm². A 20 mm long filament has a total surface area of A_{f}=152.3 mm². The total number of filaments at 20 mm long needed to represent a peni-cylinder are:

Aₛ/A_{f}=465/152.3=3.1

Three filaments were used in each testing sample set to approximately equal the surface area of one peni-cylinder surface. Metal nanoparticles were suspended throughout each filament.

The filaments were cleaved with a straight edge disposable razor cleaned with 70% or higher isopropyl alcohol. The filaments were measured against a serial surface that has two marks 20 mm apart and the filaments were cleaved to that length. The cut filaments were transferred to a 50 mL sample tube containing 25 mL of isopropyl alcohol and vortexed for 1 minute. The filaments were then removed, using tweezers that had been flame/heat sterilized, to a 50 mL sample holding container.

The antibacterial testing was performed using E. coli at levels of 10⁵, 10⁶ and 10⁷ colony forming units (CFU). Each set of three filaments were introduced to the E. coli in tryptic soy broth for 1 hour of E. coli exposure. Two sample sets (of three filaments) were used for each concentration of E. coli.

The filaments were removed from the tryptic soy broth containing the E. coli colonies and allowed to drip until the filaments were free of fluids. The filaments were then introduced to dey-engley (DE) broth with a purple color. If any E. coli bacteria grew from the filaments transferred to the DE broth, the color of the broth would turn yellow.

Samples of the DE broth were cultured for any colony growth on tryptic soy agar plates and compared with the cultures of the originally prepared 10⁵, 10⁶ and 10⁷ CFUs. Colony counts were then made after 24 and 48 hours of growth. CFUs of the E. coli were verified by agar counts: 10⁵=23 CFUs; 10⁶=256 CFUs; and 10⁷=1000 CFUs.

After 24 hours of testing there were 0 CFUs on any of the filament agar plates for all prepared concentrations of E. coli. After 48 hours of testing there were 0 CFUs on any of the filament agar plates for all prepared concentrations of E. coli. The DE broth showed no color change for all prepared concentrations of E. coli exposed to the filaments after 24 and 48 hours. There were no live bacteria on the surface of any of the filaments that were exposed for 1 hour to E. coli concentrations of the 10⁵, 10⁶ and 10⁷ CFUs. Duplicates of the testing showed the same results.

### Example 4

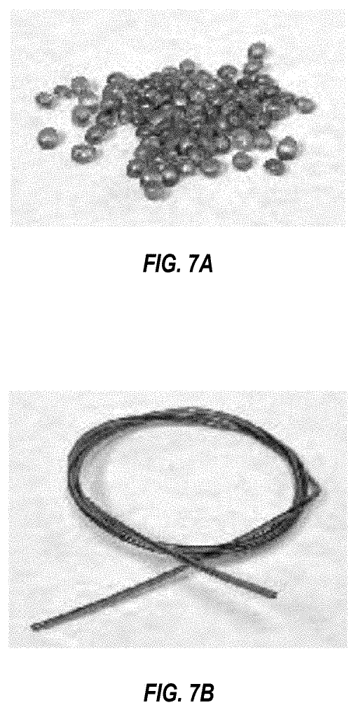

A method was successfully employed to spray industry standard pellets, illustrated in FIG. 7A. The sprayed pellets were then extruded through a hot mixer into a filament, as illustrated in FIG. 7B. The filament was cross sectioned with a diamond edge cutter to under 100 nm thickness, after encasing in ECON polymer to protect the filament from damage. Tomed slices of the filament were used for STEM/EDS imaging. The nanoparticles successfully integrated with the plastic and did show an interesting, uniform distribution that was not exclusive with the plastic polymer chains. The nanoparticles appear to be free to move about the plastic if a fluid force and temperature or energy gradient is present.

### Example 5

Spherical-shaped silver nanoparticles made by laser ablation so as to have no external bond angles or edges and which are nonionic and do not release silver ions, were tested to determine if they caused silver nanoparticle resistant bacteria. No such resistance was detected after 28 passages.

The study was entitled “Mutant generation testing on P. aeruginosa ATCC 15442, and E. coli ATCC 25922”. Two different types of spherical silver nanoparticles were tested: Silver Lot # Desktop Laser: Ag200917-104 (19 PPM) and Silver Lot # Industrial Laser: 171229-101 (16.8 PPM). The spherical-shaped silver nanoparticles made by ablation using the desktop laser had a narrow particle size distribution between 8-10 nm, and the spherical-shaped silver nanoparticles made by ablation using the industrial laser had a slightly less narrow particle size distribution between 8-12 nm,

The procedure for the study is outlined as follows:

### Bacteria Preparation

1. Streak bacteria onto tryptic soy agar (TSA) plates and incubate overnight 37° C.
2. Next day, inoculate 10 mL of silver with Mueller Hinton broth mix with one colony.
   a. Desktop laser:
      i. E. coli—Make a 4.75 ppm silver nanoparticle mix in the broth (2.5 mL Ag+7.5 mL broth).
      ii. P. aeruginosa—Make a 4.75 ppm silver nanoparticle mix in the broth (2.5 mL Ag+7.5 mL broth).
   b. Industrial laser:
      i. E. coli—Make a 2 ppm silver nanoparticle mix in the broth (1.2 mL Ag+8.8 mL broth).
      ii. P. aeruginosa—Make a 2 ppm silver nanoparticle mix in the broth (1.2 mL Ag+8.8 mL broth).
3. Incubate at 37° C. at 250 RPM 24-36 hours.
4. Monitor growth the next day.
5. Continue to serial passage in a new silver broth mixture with an inoculating loop into culture.
6. Every 5-7 days, streak out a loop of culture onto TSA plates to preserve passages then perform an MIC test on colonies to measure if the bacteria have generated resistance to the spherical silver nanoparticles.

The results of the study are as follows:

### Results MIC Values:

E. coli—Industrial laser sample: MIC held at 2 ppm out to serial passage 28.
   DT laser sample: Culture stopped regenerating after passage 21. MIC held in previous passages.
P. aeruginosa—Industrial laser sample: MIC held at 2 ppm out to serial passage 28.
   DT laser sample: Culture stopped regenerating after passage 21. MIC held in previous passages.
      All negative and positive controls passed.

### Comparative Example

A similar test is made using conventional silver nanoparticles made using a chemical synthesis process. The silver nanoparticles have external bond angles and edges and release silver ions in water. Within 6 passages anti-silver resistance is apparent from increasing MIC values.

### Additional Terms & Definitions

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

It will also be appreciated that embodiments described herein may also include properties and/or features (e.g., ingredients, components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

1. A method of manufacturing nanoparticle-embedded polymer-based products, the method comprising:
applying a nanoparticle solution to polymer granules, the nanoparticle solution comprising
metal nanoparticles, and
a volatile solvent;
heating the polymer granules containing the nanoparticle solution,
wherein heating the polymer granules causes the volatile solvent to evaporate,
wherein heating the polymer granules causes the metal nanoparticles to uniformly disperse throughout a molten polymer; and
forming the molten polymer with a uniform distribution of metal nanoparticles into a plastic-based product, wherein the plastic-based product is embedded with the metal nanoparticles.

2. The method of manufacturing of claim 1, wherein the metal nanoparticles comprise silver nanoparticles.

3. The method of manufacturing of claim 1, wherein the metal nanoparticles comprise gold nanoparticles.

4. The method of manufacturing of claim 1, wherein the metal nanoparticles comprise a combination of gold and silver nanoparticles.

5. The method of manufacturing of claim 1, wherein the embedded nanoparticles in the plastic-based product are configured to down-shift incoming UV radiation.

6. The method of manufacturing of claim 5, wherein the embedded nanoparticles down shift incoming UV radiation by at least about 50 nm, or at least about 100 nm, or at least about 150 nm, such as by approximately 200 nm.

7. The method of manufacturing of claim 1, wherein the volatile solvent is selected from the group consisting of ethanol, isopropyl alcohol, and acetone.

8. A polymer composition comprising:
a nanoparticle solution comprising a volatile solvent and metal nanoparticles; and
a plurality of polymer pellets coated with the nanoparticle solution.

9. The polymer composition of claim 8, wherein the metal nanoparticles comprise silver nanoparticles.

10. The polymer composition of claim 8, wherein the metal nanoparticles comprise gold nanoparticles.

11. The polymer composition of claim 8, wherein the metal nanoparticles comprise silver and gold nanoparticles.

12. The polymer composition of claim 11, wherein a ratio of silver to gold nanoparticles is 1:1 to about 50:1, or about 2.5:1 to about 25:1, or about 5:1 to about 20:1, or about 7.5:1 to about 15:1, or about 9:1 to about 11:1, or about 10:1.

13. The polymer composition of claim 8, wherein the metal nanoparticles are in the size range of 1 to 40 nm, or 10 to 30 nm, or 15 to 20 nm.

14. The polymer composition of claim 8, wherein the metal nanoparticles are present in a concentration of 1 to 15 ppm, or 1.5 to 10 ppm, or 2 to 5 ppm.

15. A multi-part curable resin comprising:
a first component of the multi-part curable resin;
a second component of the multi-part curable resin; and
metal nanoparticles combined with one or both of the first and second components.

16. The multi-part curable resin of claim 15, wherein the multi-part curable resin is selected from epoxy, silicone, and urethane-based.

17. The multi-part curable resin of claim 15, wherein the metal nanoparticles are selected from silver nanoparticles, gold nanoparticles, and mixture thereof.

18. The multi-part curable resin of claim 15, wherein the metal nanoparticles are spherical.

19. The multi-part curable resin of claim 18, wherein the spherical metal nanoparticles are selected from the group consisting of silver nanoparticles, gold nanoparticles, and mixture thereof.

20. The multi-part curable resin of claim 15, wherein the metal nanoparticles are coral-shaped.
